(19) United States
(12) Patent Application Publication
(10) Pub. No.: US 2023/0137611 A1
(43) Pub. Date: May 4, 2023

(54) Method for Making Sugarcane Distillate

(71) Applicant: Erik Theodorus Maria Koster, Gendringen (NL)

(72) Inventor: Erik Theodorus Maria Koster, Gendringen (NL)

(21) Appl. No.: 17/800,568

(22) PCT Filed: Feb. 18, 2021
(86) PCT No.: PCT/NL2021/050108

§ 371 Date: Aug. 18, 2022

(30) Foreign Application Priority Data
Feb. 19, 2020 (NL) 2024944

(51) Int. Cl. C12H 6/02; C12G 3/021; C12G 3/08

(52) U.S. Cl. CPC C12H 6/02; C12G 3/021; C12G 3/08

(57) ABSTRACT

Provided is a method for making sugarcane distillate, such as for instance rum, including the steps of—providing fermentation component for the yeast fermentation, which fermentation component is selected from at least one of the components sugarcane and products made completely of sugarcane, such as for instance sugarcane juice, cane sugar or sugarcane molasses; yeast fermenting the fermentation component into an alcoholic mixture; and distilling the alcoholic mixture. Before the step of yeast fermenting the fermentation component, the fermentation component is smoked by bringing the fermentation component into contact with smoke.

### CROSS-REFERENCE TO RELATED APPLICATIONS

This application is the U.S. national phase of International Application No. PCT/NL2021/050108 filed Feb. 18, 2021, and claims priority to The Netherlands Patent Application No. 2024944 filed February 19, 2020, the disclosures of which are hereby incorporated by reference in their entirety.

### BACKGROUND OF THE INVENTION

### Field of the Invention

The invention relates to a method for making sugarcane distillate, such as for instance rum, comprising the steps of:
providing fermentation component for the yeast fermentation, which fermentation component is selected from at least one of the components sugarcane and products made completely of sugarcane, such as for instance sugarcane juice, cane sugar or sugarcane molasses;
yeast fermenting the fermentation component into an alcoholic mixture;
distilling the alcoholic mixture.

### Description of Related Art

Such sugarcane distillates are for instance rum, cachac̨a and arrack. Most sugarcane distillates have been brewed for centuries in areas where cane sugar is produced. Rum is characterized inter alia in that it can be made using many different methods, which are generally characteristic of its origin.

European legislation therefore has in the form of Regulation (EU) 2019/787 a fairly broad definition of drinks which may carry the name rum. According to this legislation, rum is a distillate which is made exclusively by distilling the product obtained from alcoholic yeast fermentation of either molasses, or syrup, originating from the production of cane sugar, or the juice of the sugarcane itself, distilled to less than 96% by volume, in a manner such that the distillate can be observed to have the specific organoleptic qualities of rum. The alcohol percentage of rum lies between 37.5 and 96% by volume. No aroma or alcohol may however be added to rum.

A drawback of such sugarcane distillates, particularly rum, is that the options for obtaining a characteristic flavour palate are limited because only sugarcane may be used as component.

It is now an object of the invention to obviate the above stated drawback, or at least to provide an alternative method of making sugarcane distillate.

### SUMMARY OF THE INVENTION

This object is achieved with a method characterized in that, before the step of yeast fermenting the fermentation component, the fermentation component is smoked by bringing the fermentation component into contact with smoke.

By smoking the fermentation component, such as for instance (a mixture of) sugarcane, sugarcane juice, cane sugar or sugarcane molasses, the organoleptic spectrum of the obtained final distillate is widened without the organoleptic qualities of the original distillate being lost. A rum, within the definitions of Regulation (EU) 2019/787, with a smoke flavour can thus for instance be obtained according to the method without aromatizing the rum.

For the purpose of obtaining the desired effect the smoke used comes into contact with the fermentation component. The smoke can for instance be guided along the fermentation component.

The yeast fermentation and distillation take place under conditions known for sugarcane distillates. Yeast and water are thus added to the fermentation component for the yeast fermentation. Distillation can for instance take place using batch distillation or kettle distillation, but also using column distillation or other distillation methods. In a preferred embodiment of a method according to the invention the smoking of the fermentation component takes place at a temperature of a maximum of 25° C.

Cold smoking of the fermentation component results in no or only very limited curing of the component, and moisture is also extracted to only very limited extent. The original flavour of the fermentation component is hereby preserved as much as possible.

In an embodiment of a method according to the invention the smoking of the fermentation component takes place at a temperature higher than 25° C., preferably at a temperature in the range of 60-80° C.

Hot smoking of the fermentation component makes it possible to achieve a different organoleptic spectrum in that slight curing of the component occurs. The possible moisture balance of the fermentation component also changes due to the higher temperatures, whereby a different taste sensation can also be achieved. The smoking can for instance take place at a temperature in the range of 60-80° C., since within this temperature range the fermentation component does not dry out too quickly during smoking.

In another embodiment of a method according to the invention additional fermentation component is added after the step of smoking, which additional fermentation component is selected from at least one of the components sugarcane and products made completely of sugarcane, such as for instance sugarcane juice, cane sugar or sugarcane molasses, which additional fermentation component is not smoked.

The degree of smoke flavour in the final product can be varied by the addition, after smoking of the fermentation component, of additional, unsmoked, fermentation component.

The additional fermentation component can for instance be added before the step of yeast fermenting.

Also according to the invention is an embodiment of a method wherein the smoke comes from wood.

Smoke from smouldering or burning wood has good organoleptic qualities for the sugarcane distillate, whereby a pleasant taste sensation can be effected in a user. Wood types such as cherry, apple, birch, beech, oak, maple, hickory or pecan can for instance be used for the smoking. A distinctive flavour profile can also be obtained with combinations of wood types.

Another embodiment of a method according to the invention is a method wherein the smoke comes from peat.

Smoke from smouldering or burning peat has good organoleptic qualities for the sugarcane distillate, whereby a pleasant taste sensation can be effected in a user. It is also possible to opt for a combination of peat smoke and wood smoke.

### BRIEF DESCRIPTION OF THE DRAWINGS

These and other features of the invention are further elucidated with reference to the accompanying drawing.

FIG. 1 shows a flow diagram of a method according to the invention.

### DESCRIPTION OF THE INVENTION

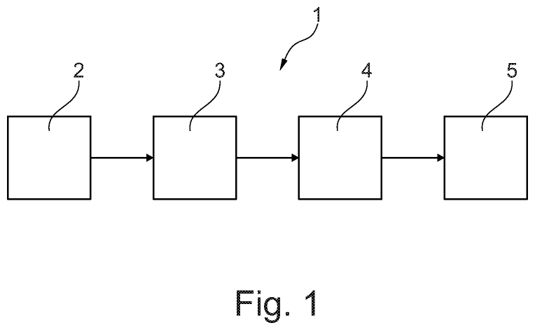

FIG. 1 shows a flow diagram 1 of a method according to the invention. In a first step 2 fermentation component is provided. The fermentation component is smoked in a second step 3. In a third step 4 the component is yeast fermented into an alcoholic mixture, which is distilled in the fourth step 5. Unsmoked additional fermentation component can optionally be added, for instance between the second step 3 and the third step 4.

1. A method for making sugarcane distillate, such as for instance rum, comprising the steps of:
providing fermentation component for the yeast fermentation, which fermentation component is selected from at least one of the components sugarcane and products made completely of sugarcane, such as for instance sugarcane juice, cane sugar or sugarcane molasses;
yeast fermenting the fermentation component into an alcoholic mixture; and
distilling the alcoholic mixture,
wherein, before the step of yeast fermenting the fermentation component, the fermentation component is smoked by bringing the fermentation component into contact with smoke.

2. The method according to claim 1, wherein the smoking of the fermentation component takes place at a temperature of a maximum of 25° C.

3. The method according to claim 1, wherein the smoking of the fermentation component takes place at a temperature higher than 25° C., preferably at a temperature in the range of 60-80° C.

4. The method according to claim 1, wherein additional fermentation component is added after the step of smoking, which additional fermentation component is selected from at least one of the components sugarcane and products made completely of sugarcane, such as for instance sugarcane juice, cane sugar or sugarcane molasses, which additional fermentation component is not smoked.

5. The method according to claim 1, wherein the smoke comes from wood.

6. The method according claim 1, wherein the smoke comes from peat.
